(19) United States
(12) Patent Application Publication
(10) Pub. No.: US 2011/0168004 A1
(43) Pub. Date: Jul. 14, 2011

(54) SYSTEM AND METHOD FOR MITIGATING AND DIRECTING AN EXPLOSION ABOARD AN AIRCRAFT

(76) Inventor: Douglas W. Henegar, Baltimore, MD (US)

(21) Appl. No.: 12/908,077

(22) Filed: Oct. 20, 2010

Related U.S. Application Data
(60) Provisional application No. 61/253,302, filed on Oct. 20, 2009.

(51) Int. Cl. F41H 5/02; B23P 11/00

(52) U.S. Cl. 89/36.02; 29/428

(57) ABSTRACT

A method and a portable inhibitor which will focus a blast from an improvised explosive device aboard a pressurized aircraft in flight by using current Federal Aviation Administration least risk bomb location (LRBL) procedures. The portable LRBL is created using a collection of inflatable cubes which interlock with one another. The cubes are made from a resilient inner bladder which is filled with halon gas or other such fire retardant gas. The outer shell is made from ballistic material such as Kevlar. The portable LRBL is stored in a deflated mode. In order for the device to be used, it must be inflated. Once inflated, the cubes will be assembled and placed at a pre-determined position on the aircraft. This location will vary depending on the type and manufacturer of the aircraft. Once the cubes are connected and stacked, the structure will provide multi layered protection to the aircraft and passengers. In addition to providing ballistic protection to the passengers, the LRBL will be filled with halon gas which is a fire retardant gas which will minimize any fireball that may be caused as a result of an explosion. The LRBL structure acts to focus the detonation of an IED in a specific direction which will blow open the door of an aircraft and the pressure inside the cabin will force the explosion outside.

This application claims the benefit of Provisional Patent Application No. 61/253,302 filed on Oct. 20, 2009, the disclosure of which is incorporated herein in its entirety by reference.

### BACKGROUND

1. Field of the Invention

The present invention relates to a system and method for mitigating damage to the airframe of an aircraft while in flight should there be a blast from an Improvised Explosive Device (“IED”). Embodiments of the present invention relate to methods and systems for utilizing the least risk bomb location (“LRBL”) procedures. The Portable Least Risk Bomb Location (PLRBL) is not designed to contain a bomb blast but to focus it in a specific direction. By focusing the force of a blast to the intended direction the PLRBL will assure the survivability of an aircraft in flight by protecting the occupants, the flight controls, and the airframe itself.

2. Description of Related Art

The hijacking of aircraft has been around since the beginning of commercial aviation. The threatened use of explosives during such operations is common to most hijacking attempts. In 1995 for instance, the Bojinka plot was a planned large-scale terrorist attack by Ramzi Yousef and Khalid Shaikh Mohammed to blow up eleven airliners and their approximately 4,000 passengers as they flew from Asia to the United States. The term can also refer to a combination of plots by Yousef and Mohammed to take place in January 1995, including a plot to assassinate Pope John Paul and crash a plane into the CIA headquarters in Fairfax County, Va., as well as the airline bombing plot.

Despite careful planning and the skill of Ramzi Yousef, the Bojinka plot was disrupted after a chemical fire drew Filipino police attention on Jan. 6 and Jan. 7, 1995 One person was killed in the course of the plot—a passenger seated near a nitroglycerin bomb on Philippine Airlines Flight 434.

Some lessons learned by the organizers of this plot were apparently used by the planners of the September 11 attacks. The money handed down to the plotters originated from Al-Qaeda, the international Islamic jihad organization then based in Sudan. This is only one instance where bombings have been used by terrorists to use violence to intimidate others for political purposes.

There have been suggestions of other proposed solutions for an in flight IED, however, the majority of these suggestions attempt to use a bucket shaped device with a lid as an attenuator. These devices may work with extremely small amounts of explosive in an open area but certainly not on a pressurized aircraft. The problem lies in the amount and type of explosive material used. A relatively new explosive, triacetone triperoxide (TATP), has recently appeared as a weapon in the Middle East. TATP is one of the most sensitive explosives known, being extremely sensitive to impact, temperature change and friction. Another peroxide-type explosive is hexamethylene triperoxide diamine (HMTD), which is less sensitive than TATP but still dangerous. HMTD is somewhat more sensitive to impact than TATP, but both are very sensitive explosives.

The tremendous devastative force of TATP, together with the relative ease of making it, as well as the difficulty in detecting it, made TATP one of the weapons of choice for terrorists since its rediscovery by Palestinian terrorist organizations in the West Bank in the early 1980's who have since used it to carry out numerous suicide bombings against Israel. Other acts of terror including two London car bombs (for which two Palestinian students were convicted of conspiracy) in July 1994 outside the Israeli embassy and a Jewish Philanthropic Institution, as well as an explosion onboard the December, 1994 Philippines Airlines flight 434 to Japan (on which Ramzi Yousef was a passenger) were perpetrated using TATP. The infamous radical Islamic “shoe bomber,” linked to al Qaeda, Richard Reid, tried to ignite a TATP fuse hidden in his shoes with a match to trigger a larger explosion. He was eventually subdued by some fellow passengers and cabin crew aboard American Airlines flight 63, but other terrorists have managed to use TATP with deadly results. The Jul. 7, 2005 London bombings, for instance, were carried out by four radical Islamic terrorists using 4.5 kg (10 lb.) of homemade TATP explosives, killing 52, injuring around 700, and terrorizing a nation. Some suspect the Madrid train bombers in 2004 used TATP, although this is disputed. Most recently, on Sep. 5, 2006, TATP was discovered during the arrest of seven suspected terrorists in Vollsmose, Denmark and the foiled August, 2006 plot to simultaneously down numerous Transatlantic flights originating from Heathrow was allegedly to have involved TATP, to have been mixed on board from liquid precursors. The increase in the attempted use of these types of explosives has led to a ban on the amount of liquids passengers may take on board a flight. In conventional high explosives such as TNT, each molecule contains both a fuel component and an oxidizing component. This type of explosion is considered an analog. Contrary to most conventional nitrogen-containing explosives, which transfer much of their energy into heat (thermal energy) in a fast exothermic reaction, peroxide-based explosives such as TATP and DADP undergo what is known as ‘Entropic Explosion’ in which there is an almost instantaneous decomposition of every solid state TATP molecule into four gas-phase molecules—one ozone and three acetone molecules. It is the accompanying enormous pressure exerted by the gas molecules (four for every one previously solid TATP) and increased entropy (disorder) of the gaseous state over that of the solid state that creates the tremendous explosive force and devastative power, 83% that of TNT and much higher than other “homemade” explosives. Most conventional explosives one might be familiar with are comparable to TNT or RDX. These are U.S. Military standard and are considered high order explosives. As previously discussed, their blasts are chemically exothermic in nature and they are used for their measurable blast size and predictability under heat and pressure. However, as one can imagine, they are difficult to obtain legally and as with most things, size matters. Conversely, TATP is highly unstable, highly explosive, and is extremely easy to manufacture. The blast produced from a small amount TATP would be tremendously harmful to a pressurized aircraft.

Historically, terrorists have used similar devices and methods in their plots and will most likely continue to utilize the same methodologies. As outlined above, the use of TATP (either for a detonator, explosive, or both) has become standard operating procedure for the modern terrorist. This means that they will continue to use it for many years to come. That being the case, the “bomb blast attenuator” type of solution would not be suitable to contain the extremely high volume of over pressure that would be created by an IED containing TATP. This type of blast containment would actually have the reverse effect. The blast pressure that would be built up would find the weakest part of the structure, exploit its flaw, and still detonate. In a high order (exothermic) explosion, the blast attenuator would actually allow the unused gas and/or accelerant, to be re-ignited by the initial blast increasing its effectiveness by 60%.

The acronym LRBL stands for Least Risk Bomb Location. LRBL is an all encompassing term commonly used in the aviation community to describe location, structure, and procedure. The location component of the LRBL is the area of an aircraft where an improvised explosive device (IED) is placed to lessen the damage caused by an explosion during flight. The structure is a stack of soft sided luggage and other common items of opportunity which are located on aircraft. The stack is constructed in a certain manner so that once the IED is placed on the pile and covered so that the blast will be contained and concentrated in a certain direction so that the door of the aircraft will be blown off and the blast will not harm the actual frame of the aircraft allowing a safe recovery of the aircraft. Current LRBL procedures include several external factors which must be achieved in order for the course of action to be a success. The LRBL process is a standard operating procedure which is mandated by the Federal Aviation Administration for all commercial aircraft operated in the United States as well as a large portion of other international carriers.

Current LRBL procedures require approximately thirty (30) minutes and several members of flight crew to construct the LRBL stack. As stated before, the LRBL protocol specifies that the stack be made from passenger luggage which is removed from overhead compartments. Several items of this procedure present potential risks. Utilizing passenger luggage to construct the LRBL poses significant risk of shrapnel and fragmentation from unknown items contained within the luggage. The potential for wheels, metal handles, and contents of luggage to become airborne is high. The hope is that if the LRBL is a success and the IED is detonated, any items which make up the LRBL that start inside the aircraft will eventually end up outside the aircraft. However, it is more probable that some items inside passenger luggage will act as projectiles and penetrate the cabin. Procedurally the luggage used must be soft sided; however, this soft sided luggage may contain anything including a second IED. The modern air traveler packs as light as possible and will over fill their carry-on bag so that they won't need to check a bag. Therefore any items they acquired during their travels will be placed inside their luggage which has potential to become airborne in the event of a detonation. Additionally, the term “soft sided luggage” can be somewhat ambiguous. In a high stress situation the flight attendant may grab any and all luggage within his/her immediate area in an effort to expedite the process; though this may cause additional collateral damage. Hard sided luggage, laptop computers and other similar fragments can damage the exterior of the aircraft or some of the actual external flight controls.

The current time and safety parameters of LRBL procedures should be of great concern to aviation officials. Since it will take a minimum of 30 minutes to build the LRBL, there can be no safe way to handle an IED if there is a timer that is outside that parameter. Current procedure dictates that if the pilot can get to the ground within the 30 minute mark he will do so and no LRBL will be built. However, if the device is on a timer and it is counting down there is not enough time to construct the LRBL. At this point, explosive ordinance disposal (EOD) personnel will be patched through to instruct airline employees how to render the device safe. Obviously, this should be the last thing any unskilled individual should do. If the IED is triggered in the wrong spot on the aircraft, it can cause a total failure of the airframe resulting in the loss of hundreds of civilian lives in the air and on the ground.

LRBL is the current accepted procedure to mitigate damage from an IED. According to the FAA all newly manufactured aircraft will be LRBL compliant in order to be air worthy in the United States. Additionally, all previously manufactured aircraft will comply with current LRBL standards by Nov. 1, 2009.

### SUMMARY OF THE INVENTION

The present invention relates to methods and systems for blast inhibition which will focus a blast from an improvised explosive device aboard a pressurized aircraft in flight by using current Federal Aviation Administration least risk bomb location (LRBL) procedures. The portable LRBL is created using a collection of inflatable cubes which interlock with one another. The cubes are made from a resilient inner bladder which is filled with halon gas or other such fire retardant gas. The outer shell is made from ballistic material such as Kevlar. The portable LRBL is stored in a deflated mode. In order for the device to be used, it must be inflated. Once inflated the cubes will be assembled and placed at a pre-determined position on the aircraft. This location will vary depending on the type and manufacturer of the aircraft.

The present invention utilizes a portable, scalable system that will decrease the amount of time it takes to build an LRBL. This system will eliminate shrapnel and fragmentation, as well as mitigate the majority of a fireball that would result from an IED blast.

For obvious reasons the location and exact procedures must remain on a need to know basis only and should be accessed by those with the proper security clearance.

The systems and methods of the present invention cut the current 30 minute LRBL to approximately five (5) minutes to build out. If necessary, the portable LRBL can be assembled by a single trained individual. By using a pre packed carrier which will contain all necessary components of the LRBL, there will be no need to travel through the passenger compartment taking luggage for the LRBL. By utilizing the pre packaged LRBL bag, there will be no mystery as to what is inside the LRBL stack. All components have a codependent job within the unit. Each component is designed with the ultimate goal of mitigating damage. The invention is designed to accomplish three basic tasks: ballistic protection, fire prevention and control and speed of action. Ideally, when using the present inventions there will be no shrapnel, no fragmentation, and little to no fire ball as a result of the blast.

The components of the portable LRBL may be manufactured to each specific class of aircraft so the components may vary slightly by size and number.

The contents of the LRBL bag may contain approximately 24-36 inflatable cubes (aircraft specific) with a male side and a female side. Either side can be laid down first, as long as the remaining cubes are interlocked with the first. These cubes may be configured to attach to one another to aid in stability of the stack. The cubes take the place of passenger luggage and will add more protection than soft sided luggage. In one embodiment, the cubes consist of a durable rubber bladder which, when expanded, will fill out a ballistic sheathing. The bladder may be of a multiple chamber design. This ballistic sheathing will assist in protecting the floor and the passenger area of the aircraft from the initial bomb blast as well as eliminating any shrapnel or fragments. In an embodiment of the present invention, the ballistic cubes are covered with hook and loop material which keeps the cubes affixed to one another once stacked next to and on top on each other.

The ballistic cubes may be filled with one of several inert gasses which will aid in the prevention and suppression of fire. The most probable family of gas used for inflation would be halogenated hydrocarbons. Halogenated hydrocarbons or halon is used throughout industry, military, and aviation to protect personnel and sensitive equipment and systems. Halon leaves no corrosive or abrasive residue after release, minimizing damage. Its nonconductive qualities make it ideal for fire suppression in electronics and electrical equipment. Halon is a fast and reliable fires suppression agent; it can be used in many unique systems or spaces including aviation applications. Halon has been approved for use by the FAA and is currently used as a fire suppression system on U.S. commercial aircraft. Being that halon is an extremely effective fire suppression agent, it will aid in immediate elimination of any fireball or internal blow back that a detonated IED may cause.

In one embodiment of the present invention, the inflation system consists of detachable gas tubes capable of inflating one cube per use. Though the gas tubes will be detachable, the cubes may be supplied with the gas tubes attached and in a ready position. Several extra tubes will be included in the kit as a failsafe measure. The inflation system may be similar to the personal flotation devices already in use by commercial aircraft. Inflation is initiated through a rip cord which will activate the gas tube and inflate the ballistic cube. The gas tubes will be contained under the ballistic skin in a built in receptacle. This pocket helps to eliminate any damage to the bladder of the cube. Additionally, the pocket will contain the gas tube and not allow it to become airborne. In the event that a gas tube fails to fire, additional tubes may be included and so that the defective tube can be removed and the replacement quickly attached allowing the ballistic cube to be put into immediate service.

Once the cubes have been inflated and stacked per LRBL procedure, the suspect device is inserted into a collapsible, adjustable ballistic “pocket.” This pocket will be adaptable to fit any size device that may be used as a suspect TED. The pocket may be a ballistic box which will be opened on one side. The open side would be placed facing the door. This design effectively makes a shape charge which concentrates the blast in the direction to which it is intended. That direction is out the door. Once the stack is built and the IED is placed on top, a lanyard is attached to the outside of the ballistic pocket. This lanyard will be stretched well past the LRBL so that if the device fails to fire, EOD technicians or bomb squad personnel can readily locate the device and render it safe. The lanyard is clearly marked in a readily identifiable color. The LRBL structure is built out from floor to ceiling and secured in place using adjustable straps which will be included in the LRBL bag. Finally, a ballistic blanket is attached to the adjustable straps using carbon fiber “D” rings and snap clamps. The ballistic blanket will catch any additional fragmentation. Once the IED is detonated the portable LRBL absorbs the blast, redirects the energy in a safe direction, and suppresses any fireball or fragmentation which may be present.

Contents of PLRBL Bag:

deflated cubes with inert gas tubes attached

spare detached failsafe gas tubes

adjustable ballistic pocket for IED

highly visible nylon lanyard

ballistic blanket

### BRIEF DESCRIPTION OF THE DRAWINGS

The accompanying drawings, which are incorporated herein and form part of the specification, illustrate various embodiments of the present invention. In the drawings, like reference numbers indicate identical or functionally similar elements.

FIG. 1 depicts the “2 left” service door of a Boeing 737 showing approx. dimensions and the location where a portable LRBL would be deployed in accordance with an embodiment of the invention.

FIG. 2 shows a perspective view of a ballistic cube showing a halon gas container inflation system in accordance with an embodiment of the invention.

FIG. 3 shows a side view depicting a half built LRBL structure with an IED containment unit and IED locater line in accordance with an embodiment of the invention.

FIG. 4 shows a side view from the aircraft aisle of fully built LRBL structure showing retention straps and IED locater line in accordance with an embodiment of the invention.

FIG. 5 shows a perspective view of an IED Containment Unit used to direct IED blast in accordance with an embodiment of the invention.

FIG. 6 shows a top view of a partially constructed LRBL structure in accordance with an embodiment of the invention.

FIG. 7 shows a perspective view of a ballistic cube in accordance with an embodiment of the invention.

FIG. 8 shows a top view of a constructed LRBL structure in accordance with an embodiment of the invention.

### DETAILED DESCRIPTION OF PREFERRED EMBODIMENTS

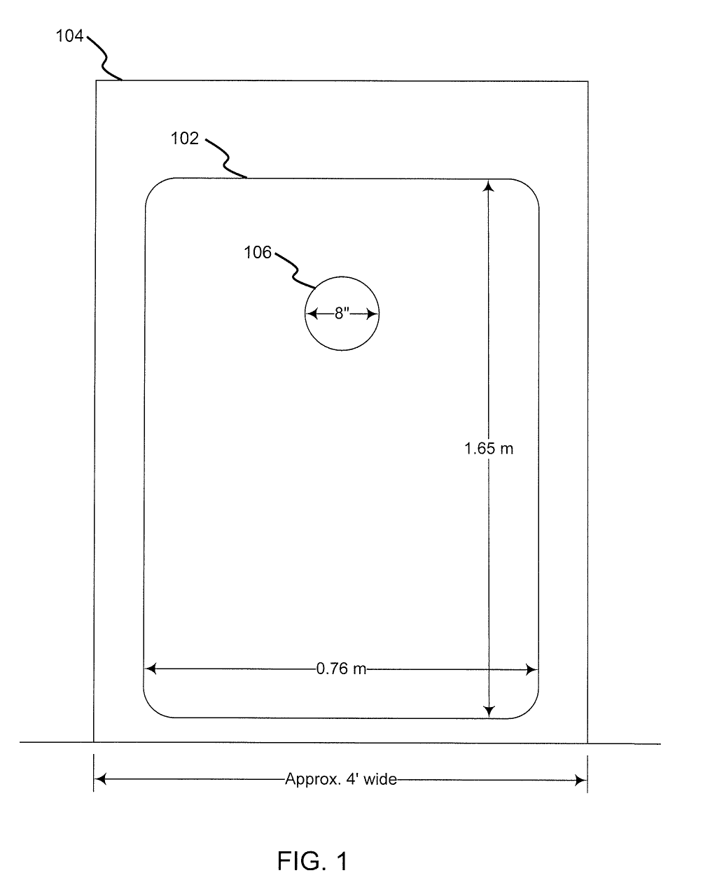

FIG. 1 shows a Boeing 737 service door 102 where the LRBL is to be built. The LRBL structure 104 is constructed to extend beyond the edges of the door. Proper assembly of the LRBL will be such that the IED will be located below the observation window 106. This is structurally the weakest part of the door. The inflatable slide/rescue raft which is attached to the door should be removed from the sheath in which it is contained. The referenced 737 was chosen as a demonstration as it is one of the most common aircraft types in U.S. aviation. However, the location and dimensions will vary depending manufacturer and model number.

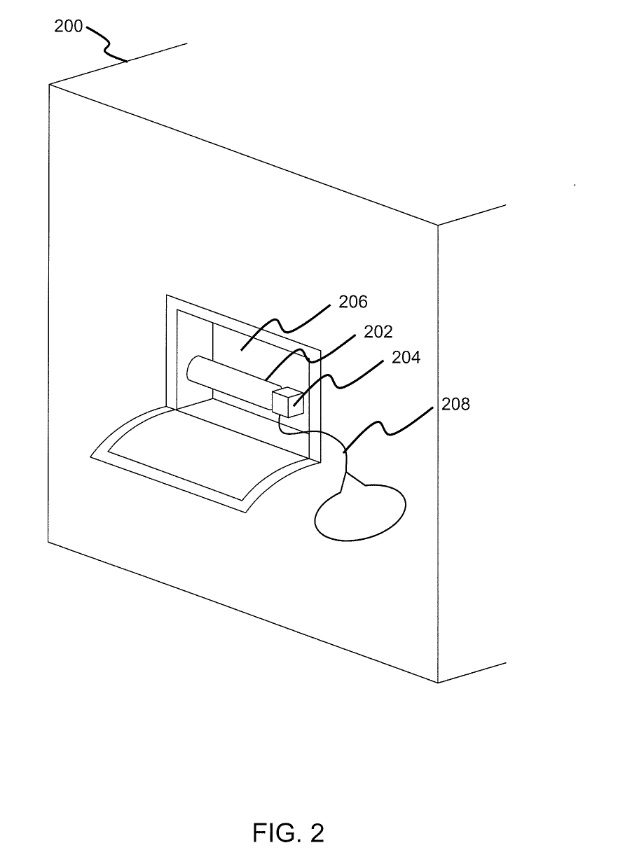

FIG. 2 shows a perspective view of a ballistic cube 200 with its inflation system exposed. The gas cylinder 202 and the inflation mechanism 204 are located inside a protected pocket 206 on the side of the cube. The inflation mechanism 204 is activated by pulling a rip cord 208. The inflation system used for inflating the ballistic cube 200 is similar to the type used for inflatable personal flotation devices such as those provided on board aircraft. Gas inflation systems such as these are well known and readily available.

The gas cylinder 202 contains pressurized gas or fluids. One example of a gas that may be used in the inflation system is halon. Halon is an inert gas which will act as a fire suppressant in case a fireball results from the explosion. Halogenated hydrocarbons or halon is used throughout industry, military, and aviation to protect personnel and sensitive equipment and systems. Halon leaves no corrosive or abrasive residue after release, minimizing damage. Its nonconductive qualities make it ideal for fire suppression in electronics and electrical equipment. While halon is a preferred gas, other non-flammable gases could also be used for inflating the ballistic cubes.

The gas cylinder 202 is constructed with threads on the nozzle portion which is fastened to the inflation mechanism 204 so that a new gas cylinder can be attached in the event of a failure. Several replacement cylinders will be included in the kit.

In one embodiment, the gas cylinder 202 is constructed such that the gas is sealed within the cylinder by a thin layer of metal or other thin material. Actuating the rip cord 208 activates a mechanism which pierces the seal on the gas cylinder and releases the gas resulting in the inflation of the ballistic cube 200. Various means are known for piercing the seal, including purely mechanical devices and electrical devices.

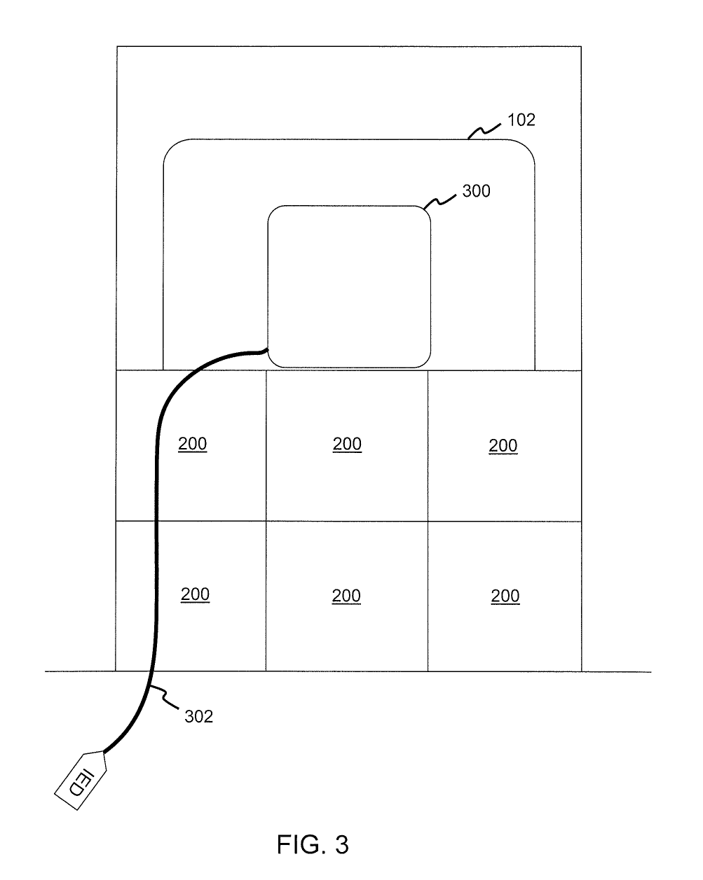

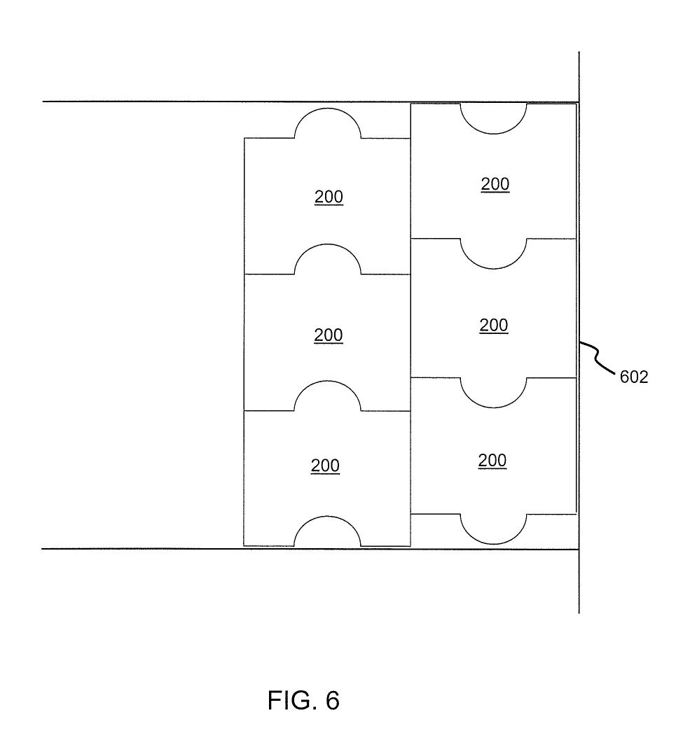

FIG. 3 shows a side view of a partially built LRBL. This view shows the first two rows of ballistic cubes 200 that have been inflated and stacked according to an embodiment of the invention. At this stage of construction, the IED should be placed in an IED containment unit 300 as shown. This will direct the blast and over pressure toward the door and beyond. Once the IED is safely in place inside the IED containment unit 300, the remaining ballistic cubes should be stacked to the ceiling and a second stack of inflated cubes should be installed behind the first as shown in top view FIG. 6. The IED locator line 302 is attached to the IED containment unit (or as close as possible). The IED locator line 302 allows emergency personnel the ability to immediately identify the location of the device so that they can either contain the IED or deactivate it.

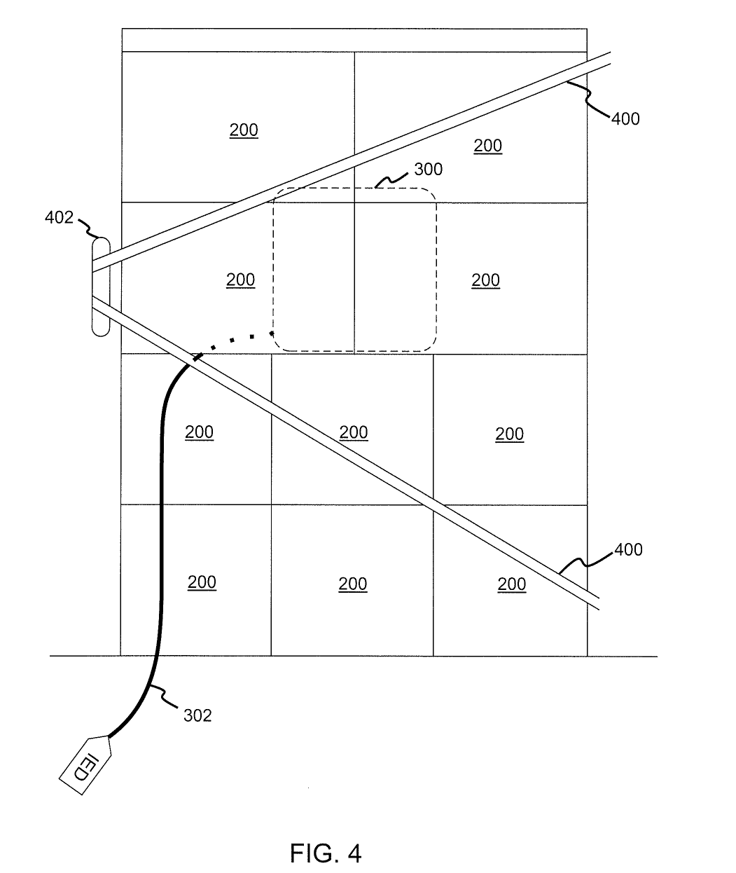

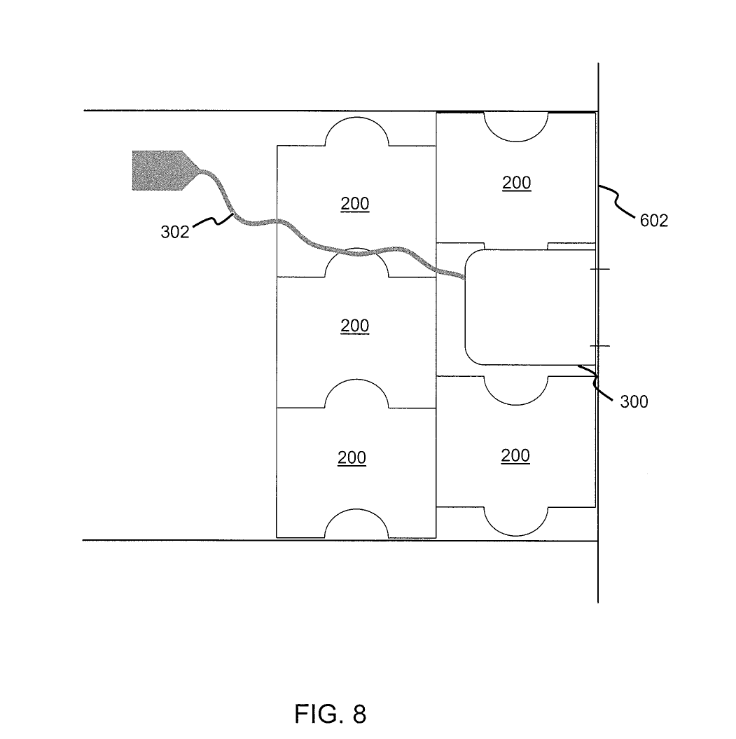

FIG. 4 shows a side view of the completed LRBL structure. This view shows a completed row of ballistic cubes 200 that have been inflated and stacked according to an embodiment of the invention. A second row of ballistic cubes 200 is located immediately behind the pictured row adjacent to the door as shown in FIGS. 6 and 8. Retention straps 400 can be attached to the emergency handles 402 which are located on either side of the service door. The straps exist to tie down the LRBL stack. This will give significant stability to the stack so that the IED will not be disturbed by the shifting of the ballistic cubes.

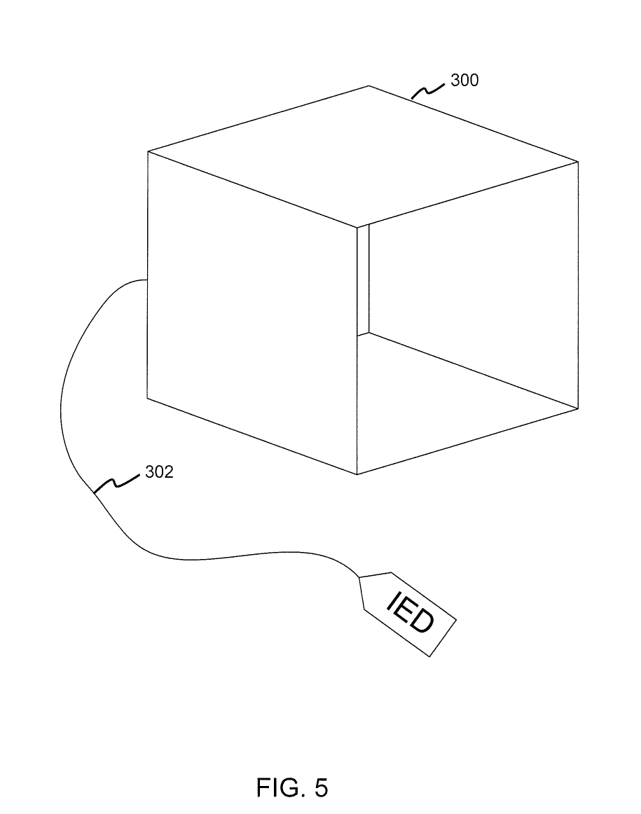

FIG. 5 shows a perspective view of an IED Containment Unit 300 used to direct IED blast with the IED locator line 302 attached in accordance with an embodiment of the invention. The IED is placed inside the collapsible IED containment unit 300 and the IED containment unit is placed on the LRBL stack with the open side toward the door or specified location on the exterior of the aircraft.

FIG. 6 shows a top view of a partially constructed LRBL structure in accordance with an embodiment of the invention. Two rows of inflated ballistic cubes 200 are stacked and placed against the outer wall 602 of the aircraft to shield the inside of the aircraft from a potential blast. Because the ballistic cubes 200 are constructed of flexible materials, the LRBL structure can be adjusted while it is being built to accommodate unforeseen obstacles or other irregularities.

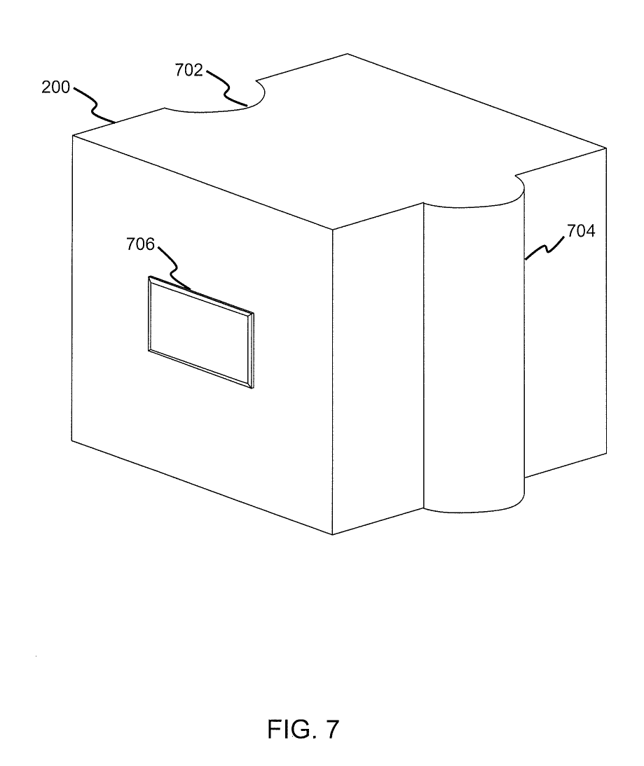

FIG. 7 shows a perspective view of a fully inflated ballistic cube 200. The ballistic cube 200 is constructed so that it will fit together with every other cube in the kit. The cut-out 702 and protrusion 704 on the cubes are designed to fit together to add additional stability and to ease construction of the structure. There will be hook and loop material on the outside of each cube so that it can fit and secure to every other cube. No matter which way the initial cube is placed on the ground, every other cube can be arranged to fit perfectly on to it. The reason for this is two-fold. First, in the event there is an IED on an aircraft, flight crews will be operating under an incredible amount of pressure. The cubes will offer visual cues as to how to build the stack. Secondly, the design will be incredibly stable and scalable at the same time. The operator will be able to adapt to any situation with no forethought only action. The halon gas cylinder 202 and the inflation mechanism 204 are located inside a protected pocket 206 on the side of the cube which is accessed by a flap 706 secured by hook and loop material. The portable LRBL is created using a collection of inflatable cubes which interlock with one another. The cubes are constructed of two layers. The inner layer is made from a resilient bladder constructed of rubber or other flexible, air-tight material. The inner bladder is inflated with halon gas or other such fire retardant gas upon activation of the inflation system. The outer shell is made from a ballistic material such as Kevlar. The portable LRBL is stored in a deflated mode. In order for the device to be used, it must be inflated. Inflation occurs by activating inflation mechanism 204. Once inflated, the cubes will be assembled and placed at a pre-determined position on the aircraft. This location will vary depending on the type and manufacturer of the aircraft.

FIG. 8 shows a top view of a completed LRBL structure with two rows of stacked inflated ballistic cubes 200 with an IED containment unit 300 and IED locator line 302 in accordance with an embodiment of the invention. Note that the open end of the IED containment unit 300 is placed with its open end toward the exterior of the aircraft so that if the IED is detonated, the blast forces will be directed toward the exterior of the aircraft. After the LRBL structure is complete, a ballistic blanket (not shown) may be attached to the adjustable straps using carbon fiber “D” rings and snap clamps. The ballistic blanket will catch any additional fragmentation. Once the IED is detonated the portable LRBL will absorb the blast, redirect the energy in a safe direction, and suppress any fireball or fragmentation which may be present.

While various embodiments of the present invention have been described above, it should be understood that they have been presented by way of example only, and not limitation. Thus, the breadth and scope of the present invention should not be limited by any of the above-described exemplary embodiments.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

What is claimed is:

1. A method of building an explosion mitigating structure comprising the steps of:
inflating a plurality of ballistic cubes;
stacking said ballistic cubes to form a plurality of vertical stacks adjacent to a predetermined location along the exterior of an aircraft;
inserting an improvised explosive device (IED) into an IED containment unit; and
placing said IED containment unit on top of said vertical stack of ballistic cubes.

2. A device for constructing a blast mitigating structure onboard an aircraft comprising:
an inflatable cube;
a container filled with a compressed gas; and
an inflation mechanism,
wherein said inflatable cube is constructed of inner and outer shells, said inner shell being a flexible, airtight material and said outer shell being a ballistic material, said inflation mechanism operating to fill said inflatable cube with the compressed gas contained in said container.

3. A system for mitigating a blast onboard an aircraft comprising:
a plurality of self-inflating inflatable cubes and
an IED containment unit,
wherein said inflatable cubes are stacked to form a plurality of rows and said IED containment unit is placed at a predetermined position within the one of said plurality of rows.
